(19) United States
(12) Patent Application Publication
(10) Pub. No.: US 2006/0198778 A1
(43) Pub. Date: Sep. 7, 2006

(54) Reduction of NOx in fluid catalytic cracking regenerator off-gas streams

(76) Inventors: Timothy A. Barckholtz, Washington, NJ (US); Theresa J. Hochhalter, Annandale, VA (US); John R. Faber, Herndon, VA (US); Cynthia M. Havran, Burke, VA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/353,487

(22) Filed: Feb. 13, 2006

Related U.S. Application Data
(63) Continuation-in-part of application No. 10/427,266, filed on May 1, 2003, now abandoned.
(63) Continuation-in-part of application No. 10/427,267, filed on May 1, 2003, now abandoned.
(60) Provisional application No. 60/386,560, filed on Jun. 5, 2002.
(60) Provisional application No. 60/386,492, filed on Jun. 5, 2002.
(60) Provisional application No. 60/442,268, filed on Jan. 24, 2003.

(51) Int. Cl. B01D 53/60

(52) U.S. Cl. 423/239.1

(57) ABSTRACT

The present invention relates to a process for reducing NOₓ concentrations in the regenerator off-gas stream of a fluid catalytic cracking unit. More particularly, the present invention relates to contacting the regenerator off-gas stream with an effective amount of a treating solution under conditions such that at least a fraction of the oxidizable NOₓ species present in the regenerator off-gas stream is oxidized to higher oxides, and at least a fraction of these higher oxides is subsequently removed from the off-gas stream. One embodiment of this invention also relates to the use of a reacted caustic solution from a wet gas scrubber for the removal of at least a fraction of the higher oxides.

### CROSS-REFERENCE TO RELATED APPLICATIONS

This application is a continuation in part of U.S. patent application Ser. Nos. 10/427,266, filed May 1, 2003, and 10/427,267, filed May 1, 2003 both of which claim benefit of the following U.S. Provisional Patent Applications: Ser. No. 60/386,560 filed Jun. 5, 2002; Ser. No. 60/386,492 filed Jun. 5, 2002; and Ser. No. 60/442,268 filed Jan. 24, 2003.

### FIELD OF THE INVENTION

The present invention relates to a process for reducing NOₓ concentrations in the regenerator off-gas stream of a fluid catalytic cracking unit. More particularly, the present invention relates to contacting the regenerator off-gas stream with an effective amount of a treating solution under conditions such that at least a fraction of the oxidizable NOₓ species present in the regenerator off-gas stream is oxidized to higher oxides, and at least a fraction of these higher oxides is subsequently removed from the off-gas stream. One embodiment of this invention also relates to the use of a reacted caustic solution from a wet gas scrubber for the removal of at least a fraction of the higher oxides.

### BACKGROUND OF THE INVENTION

Increasingly stringent government regulatory emission standards have led refiners to explore improved technologies for reducing the concentration of nitrogen oxides (“NOₓ”) in emissions from combustion and production effluent or waste gas streams. For example, the technology taught in U.S. Pat. No. 3,957,949 to Senjo et al., teaches a method for removing low-soluble pollutants, such as mercury and NO, from waste gas streams by use of an oxidizing agent that is released from a compound, such as sodium chlorite, that is injected into a recycle stream. Also, U.S. Pat. No. 6,294,139 to Vicard et al., discloses a method for removing nitrogen oxides from waste gas streams by oxidizing nitrogen oxide with chlorine dioxide or ozone, then bringing the oxidized gas in contact with sodium chlorite in a water solution. But since these oxidants are expensive and it is desired that they be utilized to oxide nitrogen species, the process stream must first be thoroughly pre-treated to remove all or almost all SOₓ prior to contacting the stream with the oxidant for NOₓ conversion and removal.

Further, it is known in the art to reduce NOₓ concentrations in combustion effluent streams by the injection of ammonia, see U.S. Pat. No. 3,900,554 to Lyon. After the Lyon patent, there was a proliferation of patents and publications relating to the injection of ammonia into combustion streams in order to reduce NOₓ concentration. Such patents include U.S. Pat. No. 4,507,269, Dean et al., and U.S. Pat. No. 4,115,515, Tenner et al..

Even so, effluents released via the regenerator off-gas of a fluidized catalytic cracking (“FCC”) unit, remain a major source of NOₓ emissions from the petrochemical industries. In a petrochemical complex, the FCC unit is often the largest source of NOₓ emissions. NOₓ is formed in the regenerator of the FCC during the combination of nitrogen compounds with oxygen and/or air, and leaves in the form of a regenerator off-gas. Although the NOₓ is extremely dilute in the regenerator off-gas (in the ppm range), the overall emissions of NOₓ are considerable due to the high volumetric flow rate of the FCC unit off-gas stream. Even though NOₓ concentrations in the off-gas are typically in the range of 50-200 ppmv, at these concentrations, a typical FCC unit can emit over 1000 tons of NOₓ per year. NOₓ species are regulated pollutants by the United States Environmental Protection Agency (“EPA”) and failure to meet the EPA's industrial emissions regulations can result in significant fines, or even production slowdowns or shutdowns in order to remain within regulatory compliance.

To meet these regulatory requirements, many fluidized catalytic cracking process units incorporate wet gas scrubbers to remove attrited catalyst fines, with the ancillary benefit of these wet gas scrubbers reducing SOₓ. While conventional wet scrubbing is effective for reducing SOₓ emissions, it is not effective for reducing NOₓ emissions. A majority (typically over 90%) of the NOₓ contained on FCC unit's regenerator off-gas stream is in the form of NO, which is not water-soluble and the majority of the remainder of NOₓ is in the form on NO₂ which is only slightly water-soluble. Further, the solubility of NO₂ decreases as its gaseous concentration decreases, because its solubility is second-order in its concentration.

One approach to reducing NO emissions involves oxidizing lower oxide NOₓ species to higher oxides. However, the many of the conventional methods involve either chemicals that require extended reaction periods or can create ancillary problems within the processing unit. Such problems include, for example, corrosion of materials of construction, problems with treating the waste water from the unit, as well as problems relating to the removal of SOₓ species that are typically also present. For example, it is known in the art to add sodium chlorite (NaClO₂) to the wet gas scrubber liquor to oxidize NOₓ species to higher oxides such as, for example, to NO₂ which is more water-soluble than NO and which can be more readily removed from the process system, typically as nitrate and/or nitrite.

However, the addition of sodium chlorite to the scrubber liquor has its disadvantages. For example, sodium chlorite is a costly chemical and can be consumed by side reactions, such as the oxidation of SOₓ species to higher sulfur oxides (e.g., SO₃²⁻ to SO₄²⁻). Thus, because sodium chlorite does not selectively oxidize lower oxide NOₓ species to higher oxides, conventional methods require the use of relatively high sodium chlorite concentrations in the scrubber liquor to achieve the desired absorption removal of oxidizable NOₓ species. These high levels of sodium chlorite lead to high chloride levels that cause, among other things, corrosion of the scrubber's materials of construction. In addition, maintaining high levels of sodium chlorite may not be financially attractive.

Another problem in the prior art is the lack of an effective and cost-efficient absorption solution for removing the converted NO₂ from the FCC regenerator off-gas stream. Final wash systems in the art, comprised of water and/or alkali solution such as described in U.S. Patent Application Number US 2004/0214187 A1 to Johnson et al., are relatively ineffective for removal of NO₂, especially at NO₂ concentrations below 100 ppmv.

Thus, there still is a need in the art for an economical and effective method to reduce the level of NOₓ species from regenerator gas streams. This includes the need in the industry for a process that is effective, efficient, and economic to remove NOₓ within restrictions of existing facilities which have limited control over the size of the off-gas treating equipment (e.g., the wet gas scrubber) and are not able to perform adequate removal of entrained sulfite-laden water droplets from the first SOₓ reaction zone to allow the processes of the prior art to convert and remove the NOₓ in the regenerator off-gas to the efficiencies required by current and future environmental emissions restrictions.

### SUMMARY OF THE INVENTION

One embodiment of the present invention is a process for reducing NOₓ concentrations in the regenerator off-gas stream of a fluid catalytic cracking unit, which stream contains both NOₓ and SOₓ species, which process comprises:
a) removing at least a fraction of the SOₓ species from said regenerator off-gas stream in a first reaction zone thereby producing a SOₓ depleted off-gas stream;
b) contacting said SOₓ depleted off-gas stream in a second reaction zone with an effective amount of a treating solution comprised of sodium hypochlorite and an oxidant selected from sodium chlorite and chlorine dioxide at conditions that will oxide at least a fraction of the sulfites in said SOₓ depleted off-gas stream to sulfate and oxidize at least a fraction of the oxidizable NOₓ species in said SOₓ depleted off-gas stream to higher nitrogen oxides to produce a NO depleted off-gas stream; and
c) removing at least a fraction of said higher nitrogen oxides from said NO depleted off-gas stream to produce a treated regenerator off-gas stream.

In a preferred embodiment, said sodium hypochlorite is introduced at a molar ratio from about 0.3 to about 3.0 moles of sodium hypochlorite per mole of sulfite in said second reaction zone.

In another preferred embodiment, said oxidant is introduced at a molar ratio from about 0.5 to about 3.0 moles of oxidant per mole of NO in said second reaction zone.

In another preferred embodiment, the NO Oxidation Efficiency of the process is at least 70%.

In a more preferred embodiment, the NOₓ concentration of said treated regenerator off-gas stream is at least 30% lower than the NOₓ concentration of said regenerator off-gas stream.

Another preferred embodiment of the present invention is a process for reducing NOₓ concentrations in the regenerator off-gas stream of a fluid catalytic cracking unit, which stream contains both NOₓ and SOₓ species, which process comprises:
a) removing at least a fraction of the SOₓ species from said regenerator off-gas stream in a first reaction zone thereby producing a SOₓ depleted off-gas stream;
b) contacting said SOₓ depleted off-gas stream in a second reaction zone with an effective amount of a treating solution comprised of sodium hypochlorite and an oxidant selected from sodium chlorite and chlorine dioxide at conditions that will oxide at least a fraction of the sulfites in said SOₓ depleted off-gas stream to sulfate and oxidize at least a fraction of the oxidizable NOₓ species in said SOₓ depleted off-gas stream to higher nitrogen oxides to produce a NO depleted off-gas stream; and
c) contacting said NO depleted off-gas stream in a third reaction zone with an effective amount of an absorption solution comprised of the waste gas scrubber slurry solution from the bottom collection zone of a wet gas scrubber at conditions that will absorb at least a portion of the NO₂ in said NO depleted off-gas stream to produce a treated regenerator off-gas stream.

In another preferred embodiment, said sodium hypochlorite is introduced at a molar ratio from about 0.3 to about 3.0 moles of sodium hypochlorite per mole of sulfite in said second reaction zone.

In another preferred embodiment, said oxidant is introduced at a molar ratio from about 0.5 to about 3.0 moles of oxidant per mole of NO in said second reaction zone.

In another preferred embodiment, the NO Oxidation Efficiency of the process is at least 70%.

In another preferred embodiment, the Oxidation Products Removal Efficiency of the process is from about 50% to about 60%.

In more preferred embodiment, said absorption solution is introduced at a molar ratio of at least 2.0 moles of sulfite per mole of NO₂ in said third reaction zone.

### BRIEF DESCRIPTION OF THE FIGURES

FIG. 1 illustrates a schematic of one preferred embodiment of the present invention wherein the treating solution of the present invention is introduced into the process above a lower contacting grid.

FIG. 2 illustrates a schematic of one preferred embodiment of the present invention wherein the treating solution of the present invention is introduced into a waste gas scrubber process above a lower contacting grid in conjunction with the absorption solution of the present invention injected into a waste gas scrubber process above an upper contacting grid.

FIG. 3 illustrates a schematic of one preferred embodiment wherein the absorption solution of the present invention is filtered for particulates prior to introduction into a waste gas scrubber process above an upper contacting grid.

FIG. 4 illustrates a schematic of one preferred embodiment wherein at least a portion of the reacted absorption solution of the present invention that is removed from collection tray under the upper contacting gird is returned to the upper contacting grid.

FIG. 5 is a data plot from a first test run of one of the embodiments of present invention on a commercial fluid catalytic cracking unit regenerator off-gas stream.

FIG. 6 is a data plot from a second test run of two of the embodiments of present invention on a commercial fluid catalytic cracking unit regenerator off-gas stream.

FIG. 7 is a data plot from a third test run of two of the embodiments of present invention on a commercial fluid catalytic cracking unit regenerator off-gas stream.

### DETAILED DESCRIPTION OF THE PRESENT INVENTION

As used herein, the terms NOₓ, NOₓ species, and nitrogen oxides refer to the various oxides of nitrogen that may be present in combustion waste gasses. Thus, the terms refer to all of the various oxides of nitrogen including, but not limited to, nitric oxide (NO), nitrogen dioxide (NO₂), dinitrogen tetroxide (N₂O₄), dinitrogen pentoxide (N₂O₅), and mixtures thereof. When sodium chlorite or chlorine dioxide is the oxidant, products may also include ClNO₂ and ClNO₃. For this reason, the terms “oxidation products” and “higher oxides” refer to the higher nitrogen oxides as well as the two chlorinated compounds. Also, the term “lower nitrogen oxide” refers to nitrogen oxides that are oxidizable to higher oxides. Nitric oxide (NO) is the most preferred nitrogen oxide to be oxidized since the majority of the nitrogen oxides in a typical FCC unit's off-gas stream treated by the present invention is NO. Therefore, in one embodiment, the process is especially concerned with the removal and control of NO in the regenerator off-gas stream.

The terms FCCU regenerator off-gas, regenerator off-gas, and off-gas are used interchangeably herein. Also, the terms wet gas scrubber, scrubbing apparatus, and scrubber may also be used interchangeably herein.

The present invention provides an efficient process for removing NOₓ species from the regenerator off-gas stream generated by a fluidized catalytic cracking process unit and achieving very low final NOₓ emissions levels in this stream. The instant process involves adding an effective amount of a treating solution to the off-gas stream under conditions effective for oxidizing at least a fraction of the lower nitrogen oxides, particularly NO, contained in the off-gas stream to higher oxides. As used herein, an effective amount of the treating solution is an amount that oxidizes at least a fraction of the NO present in the off-gas stream. By at least “a fraction”, it is meant at least about 80%, more preferably at least 85% and most preferably at least 90% of the NO present in the off-gas stream is oxidized to higher oxides.

The treating solution in this invention is comprised of a mixture of sodium hypochlorite (also referred to as “NaClO”) and either sodium chlorite (also referred to as “NaClO₂”) or chlorine dioxide (also referred to as “ClO₂”). By utilizing this treating solution of the present invention in a process with the regenerator off-gas stream of an FCC unit, very low levels of NOₓ emissions may be achieved. It has been discovered that these low levels of NOₓ emissions may be achieved due to a complex series of chemical reactions associated with the compounds of this invention. In the particular configurations of the present invention, it is believed that the sodium hypochlorite reaction not only aids reactions that oxidize NO to higher oxides as in the present art, but also preferentially oxidizes sulfites, thus allowing a more efficient use of the sodium chlorite or chlorine dioxide to convert the NO in the off-gas stream to higher oxides. The level of NOₓ emissions from the regenerator off-gas can ultimately be reduced to much lower levels as the oxidation products that are formed such as, for example, NO₂, ClNO₂ and ClNO₃, are more easily removed than are the lower nitrogen oxides, in particular NO.

As discussed, the addition of an oxidizing agent such as sodium chlorite or sodium hypochlorite to a scrubber liquor to oxide NO to higher nitrogen oxides is described in U.S. Pat. No. 6,294,139, Vicard et al.. However, it has not been understood that the combination of such compounds can significantly improve the efficiency and ultimate level of NOₓ reduction as well as minimize the overall cost of the NOₓ removal treatment. While the prior art has been concerned with utilizing sodium hypochlorite as a NO oxidizing agent, it has been discovered that sodium hypochlorite can be utilized to oxide sulfites in preference to NO. If the sodium hypochlorite is not utilized when treating the regenerator off-gas stream, the sodium chlorite (or chlorine dioxide) will react with the sulfites that are entrained by the off-gas in preference to the desired reaction of oxidizing the NO to higher level nitrogen oxides. This increases the costs of treating the off-gas stream and can limit the overall efficiency and NOₓ reduction levels achieved by the stream treatment system.

This non-preferential oxidation reaction may lead to injecting relatively high levels of sodium chlorite into the waste gas stream in order to remove a satisfactory amount of NOₓ species present in the waste gas stream. As discussed, these high levels of sodium chlorite have the undesirable effects of causing corrosion of the scrubber hardware, causing problems associated with waste water treatment, as well as increasing the costs of reagents. The present invention improves the overall cost, reduces the problems associated with excessive sodium chlorite injections, and increases the overall NOₓ reduction efficiencies.

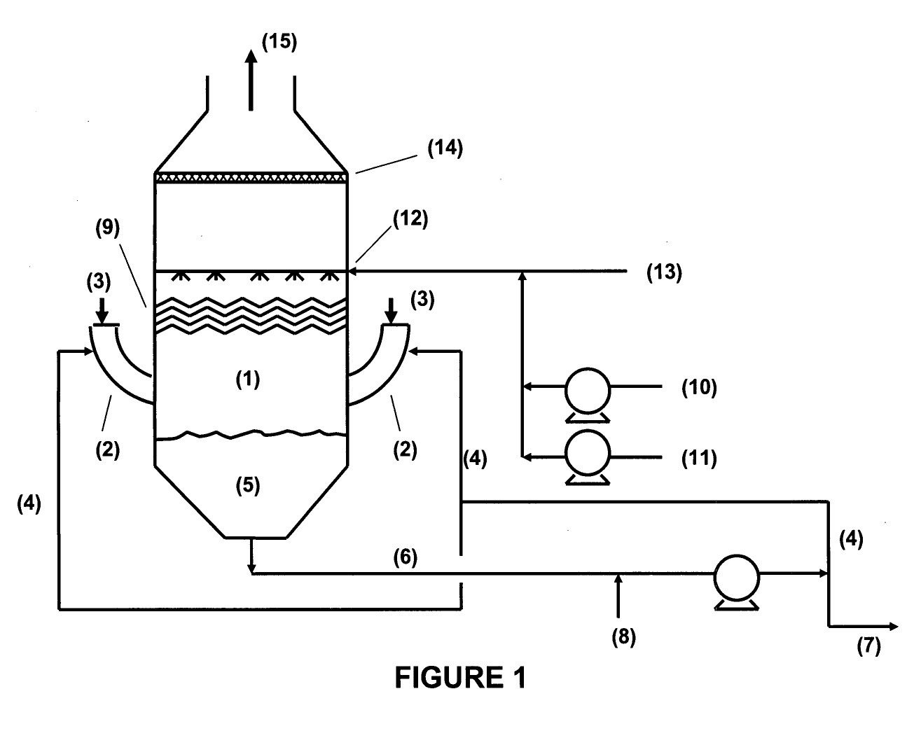

A complex series of reactions governs the overall oxidation processes associated with reducing pollutant emission levels from an FCC regenerator off-gas stream containing SOₓ and NOₓ. FIG. 1 illustrates a typical FCC wet gas scrubber incorporating one embodiment of the present invention. It is common practice and known in the art that the regenerator off-gas can be cooled through various methods to a temperature of about 400 to about 600° F. and then conducted to a wet gas scrubbing unit (1). In the venturi nozzles (2) of the wet gas scrubbing unit the entering regenerator off-gas (3) is normally contacted with a circulating aqueous caustic solution (4) that is at a temperature of about 100 to 150° F. While not wishing to be held to any specific theory or model, it is believed that in this section (also later referred to as the “first reaction zone”) the following chemical reactions occur:
SO₂+2H₂O→H₃O⁺+HSO₃⁻ (1)
NaOH+HSO₃⁻→NaHSO₃+OH⁻ (2)
H₃O⁺+HSO₃⁻+Na₂SO₃→NaHSO₃+H₂O (3)
NaHSO₃+NaOH→Na₂SO₃+H₂O (4)
As can be seen, a significant amount of the reactions in this first reaction zone of the process result in the formation of sulfite compounds. The reactions in this first reaction zone are very ineffective in converting NO to NO₂ or higher oxides. NO oxidation efficiencies in this first reaction zone are typically essentially zero.

Returning to FIG. 1, a majority of reaction products and entrained catalyst fines descend from the outlet of the venturi nozzles into the reacted caustic solution collection at the bottom of the wet gas scrubber (5). The collected reacted caustic solution is removed for the wet gas scrubber (6) and most often sent to a purge treatment wherein most of the entrained solids can be removed and some of the sulfite can be oxidized (7). Additional caustic solution and/or water (8) can be added to the re-circulation circuit as necessary to make-up for solution lost to evaporation and purging and to maintain a proper pH level in the re-circulated caustic solution. A major problem in the current art is that an appreciable amount of the reaction products generated in this first reaction zone are in the form of liquid droplets which remain entrained in the off-gas and collect on the contacting grid (9) of the wet gas scrubber unit. These entrained liquids contain sulfites (SO₃²⁻) along with residual SOₓ and NOₓ species in the off-gas which can coat onto the high-area contacting grid.

In accordance with one embodiment of the present invention, a first treating solution comprised of a combination of sodium hypochlorite (10) and sodium chlorite (or chlorine dioxide) (11) is injected via a spray header (12) above the contacting grid (9) of the wet gas scrubber. This section of the process may also be later referred to as the “second reaction zone”. Water (13) is added to the treating solution stream. It is preferred that at least some water be combined with the sodium hypochlorite (10) and sodium chlorite (or chlorine dioxide) (11) streams in order to maximize contact with the off-gas stream, provide a medium for absorbing the converted water-soluble species, and minimizing corrosive effects. The desired reaction for the sodium chlorite (after conversion to chlorine dioxide) or the chlorine dioxide is to convert NO to oxidation products which may be absorbed by an aqueous contact solution and removed from the flue gas. However, the problem in the current art is that the sodium chlorite (or chlorine dioxide) has a preferred reaction with any remaining sulfites (SO₃²⁻) that are entrained in the off-gas and distribute upon the high-area structure of the contacting grid (9).

It has been discovered that if sodium hypochlorite is included in the treating solution, the sulfites present in this second reaction zone will react with the sodium hypochlorite in the treating solution in preference to the sulfite reacting with the sodium chlorite or chlorine dioxide. The use of sodium hypochlorite allows the chlorine dioxide in the treatment wash stream to react with the NOₓ in the flue gas to oxidize the NO species to water-soluble compounds which may then be removed from the system. However, if excessive sodium hypochlorite is used, it will react with the sodium chlorite and neither compound will be effective in oxidizing the NO to higher oxide species.

While not wishing to be bound by any theory or model, it is believed that absent the presence of sulfites in the off-gas stream, the competing reactions between the regenerator off-gas stream and the treating solution of the present invention in the contacting grid section are complex and are as follows:
2ClO₂⁻(aq)+HOCl(aq)→2ClO₂(aq)+Cl⁻(aq)+OH⁻(aq) (5)
ClO₂(aq)→ClO₂(g) (6)
ClO₂(g)+NO(g)→ClO(g)+NO₂(g) (7)
ClO(g)+NO(g)→Cl(g)+NO₂(g) (8)
ClO(g)+NO(g)→ClNO₂(g) (9)
Cl(g)+NO₂(g)→ClNO₂(g) (10)
ClO(g)+NO₂(g)→ClNO₃(g) (11)
2Cl(g)→Cl₂(g) (12)
ClNO₂(g)→ClNO₂(aq) (13)
ClNO₃(g)→ClNO₃(aq) (14)
Cl₂(g)→Cl₂(aq) (15)
ClNO₂(aq)+H₂O(aq)→2H⁺(aq)+Cl⁻(aq)+NO₃⁻(aq) (16)
ClNO₃(aq)+H₂O(aq)→HOCl(aq)+H⁺(aq)+NO₃⁻(aq) (17)
Cl₂(aq)+H₂O(aq)→HOCl(aq)+Cl⁻(aq)+H⁺(aq) (18)

In these reactions, NO is converted to NO₂, ClNO₂, and ClNO₃ wherein the ClNO₂, ClNO₃, and Cl₂ can be absorbed and removed by the aqueous solution on the grid. However, while the NO₂ formed is more soluble than NO in aqueous solutions, it is not appreciably soluble at the low concentrations of an FCC unit and most of the NO₂ remains in the off-gas. Sulfites (SO₃²⁻), bisulfites (HSO₃⁻) and sulfates (SO₄²⁻) remain entrained in the off-gas and collect upon the contacting grid (9). The chlorine dioxide is more reactive with the sulfites and bisulfites than its desired reaction with the NO in the flue gas. In the presence of sulfites or bisulfites, the chlorite is converted according to the following equations:
ClO₂⁻(aq)+2SO₃²⁻(aq)→2SO₄²⁻(aq)+Cl⁻(aq) (19)
ClO₂⁻(aq)+2HSO₃⁻(aq)→2SO₄²⁻(aq)+Cl⁻(aq)+2H⁺(aq) (20)

Therefore, in the present invention, sodium hypochlorite is added with the sodium chlorite or chlorine dioxide in the aqueous wash stream prior to the contacting grid (9) of the wet gas scrubber to preferentially remove the residual sulfites and bisulfites to allow the chlorites to remain free to react with the NO in the off-gas stream in this second reaction zone. It is believed that sodium hypochlorite is converted to hypoclorous acid and the following equations depict the chemical reactions that take place:
NaOClU(aq)→Na⁺(aq)+ClO⁻(aq) (21)
ClO⁻(aq)+H⁺(aq)⇄HOCl(aq) (22)
HOCl(aq)+SO₃²⁻(aq)→SO₄²⁻(aq)+Cl⁻(aq) (23)
HOCl(aq)+HSO₃⁻(aq)→SO₄²⁻(aq)+Cl⁻(aq)+2H⁺(aq) (24)
It should be noted that reactions (23) and (24) are considerably faster than their counterparts (19) and (20) allowing the sulfites to be preferentially removed through reactions with the sodium hypochlorite in the present invention and thereby allowing the chlorine dioxide to remain free for its desired reaction to oxidize the NO in the off-gas stream.

A substantial amount of the entrained sulfites are converted to aqueous sulfates and are captured in the grid region (9) by collection of the droplets on the grid and migrate down into the bottom of the wet gas scrubber (5) where they are removed. The treated off-gas stream (15) now lower in entrained sulfite-laden water droplets and with a lower concentration of NO, NOₓ and SOₓ species leaves the wet gas scrubber preferably after passing through a disengaging grid or packing (14). A water wash may be applied in the vicinity of the disengaging grid or packing to help facilitate the absorption and removal of NOₓ and SOₓ higher oxide species from the treated off-gas before it leaves the wet gas scrubber.

It should be noted that the SOₓ removal method employed in the first reaction zone is not essential to the present invention and may be any effective method. However, it is preferred that some of the SOₓ be removed from the regenerator off-gas stream prior to introducing the treating solution comprised of sodium hypochlorite and sodium chlorite or chlorine dioxide. In one embodiment, the SOₓ removal method preferably reduces the levels of SOₓ species in the off-gas stream to below about 100 ppm, preferably below about 50 ppm, and more preferably below about 10 ppm before the treating solution is mixed with the off-gas stream. It is most preferred to remove substantially all of the SOₓ species present in the off-gas stream before the treating solution is mixed with the off-gas stream. Non-limiting examples of SOₓ removal processes suitable for use herein include wet desulfurization methods such as catalyst additives, water scrubbing, alkali scrubbing, magnesia scrubbing, and ammonium scrubbing, as well as dry desulfurization methods such as using manganese oxide or activated carbon. Preferably, the SOₓ species are removed by a wet desulfurization method, most preferably by use of a wet gas scrubber. Pre-removal of most of the SOₓ not only decreases the required amounts of treating solution compounds required, but also reduces the amount of corrosion and disposal problems associated with excessive use of chlorine containing compounds.

In the present invention, there should be sufficient sodium hypochlorite in the treating solution to effectively oxidize most, preferentially substantially all of the sulfites present in the off-gas in the region of the lower grid of the wet gas scrubber immediately below where the treating solution is being introduced. Accordingly, sodium hypochlorite should be added to the process in about 0.3 to about 3.0 moles of sodium hypochlorite to each mole of sulfite present in the off-gas in the lower grid region. Preferably, this ratio should be about 0.5 to about 2.0, and more preferably, about 0.5 to about 1.5 moles of sodium hypochlorite to each mole of sulfite present in the off-gas in the lower grid region. However, the amount of sodium hypochlorite required for an application is difficult to directly determine, as the amount of entrained droplets and sulfite concentrations in the region are difficult to measure.

In addition, these ratios may be affected by many variables including, but not limited to, off-gas velocities in the system, the amount of entrainment of water droplets in the system, effective grid area available, the concentration of NOₓ and sulfites in the off-gas, as well as other equipment and process variables and limitations. Therefore, testing of a particular system at various sodium hypochlorite injection ratios should be utilized to determine the optimum amount of sodium hypochlorite for a particular application.

The oxidant selected from sodium chlorite or chlorine dioxide (depending upon which is utilized) should be injected at a molar ratio to the NO present in the off-gas in the lower grid region of about 0.5 to about 3.0, preferably about 0.5 to about 2.0, and more preferably about 0.6 to about 1.5. Preferably a higher molar ratio will be utilized due to inefficiencies in mixing of the solution with the off-gas and competing reactions which may utilize some of the sodium chlorite or chlorine dioxide available. Similar to the amount of sodium hypochlorite required, the optimal amount of sodium chlorite (or chlorine dioxide) may be dependent upon many equipment and process variables and limitations and testing of a particular system at various sodium chlorite or chlorine dioxide injection ratios should be utilized to determine the optimum and most cost-effective amount required for a particular application.

Another consideration that must be made in optimizing the amount of sodium hypochlorite and the oxidant selected from sodium chlorite and chlorine dioxide to be utilized in a particular system is that higher sodium hypochlorite to oxidant ratios may contain an excessive amount of sodium hypochlorite, as well as increase the risk of the sodium hypochlorite and the oxidant excessively reacting which each other forming sodium chlorate and sodium chloride and reducing the overall effectiveness of the system in oxidizing the NO to higher oxide species. It is therefore preferable to maintain the sodium hypochlorite to oxidant molar ratios at about 0.2 to about 1.5, more preferably from about 0.2 to about 1.0 and most preferably from about 0.3 to about 0.8.

After at least a fraction of the oxidizable NOₓ species is oxidized to oxidation products (or “higher oxides”), at least a fraction of these oxidation products can be removed. The removal of these oxidant products may be accomplished by any effective process.

The embodiment illustrated in FIG. 1 and described above utilizes a treating solution comprised of sodium hypochlorite and either sodium chlorite or chlorine dioxide to effectively convert the sulfites in the contacting grid to sulfates and allow the sodium chlorite to act effectively in the conversion of the NO in the off-gas stream to soluble species that can be more readily absorbed from the off-gas stream. This prior embodiment is very effective in converting the NO to oxidant products with attainable NO Oxidation Efficiencies of at least 80%, preferably at least 85%, and more preferably at least 90%. The NO Oxidation Efficiency for the system is expressed as a percentage and calculated by the formula:

$$\frac{{NO}_{in} - {NO}_{out}}{{NO}_{in}} \times 100 ( \% ) \qquad ( 25 )$$

where,
NOᵢₙ is the amount of NO in the off-gas prior to treatment by the present invention (in ppm), and
NOₒᵤₜ is the amount of NO in the off-gas after treatment by the present invention (in ppm)

However, the treating solution that is utilized in this second reaction zone is not very effective as an absorption solution for removing the oxidant products that are formed. Absorption efficiencies of only about 30 to 50% can generally be achieved in this second reaction zone while achieving NO Oxidation Efficiencies greater than about 80%. In this embodiment, the NO Oxidation Efficiency is at least 60%, preferably at least 70%, and more preferably at least 80%. However, providing the system is properly designed and there are no significant limitations on the size of the system, a NO Oxidation Efficiency of at least 90%, preferably at least 95%, and more preferably substantially 100% may be achieved.

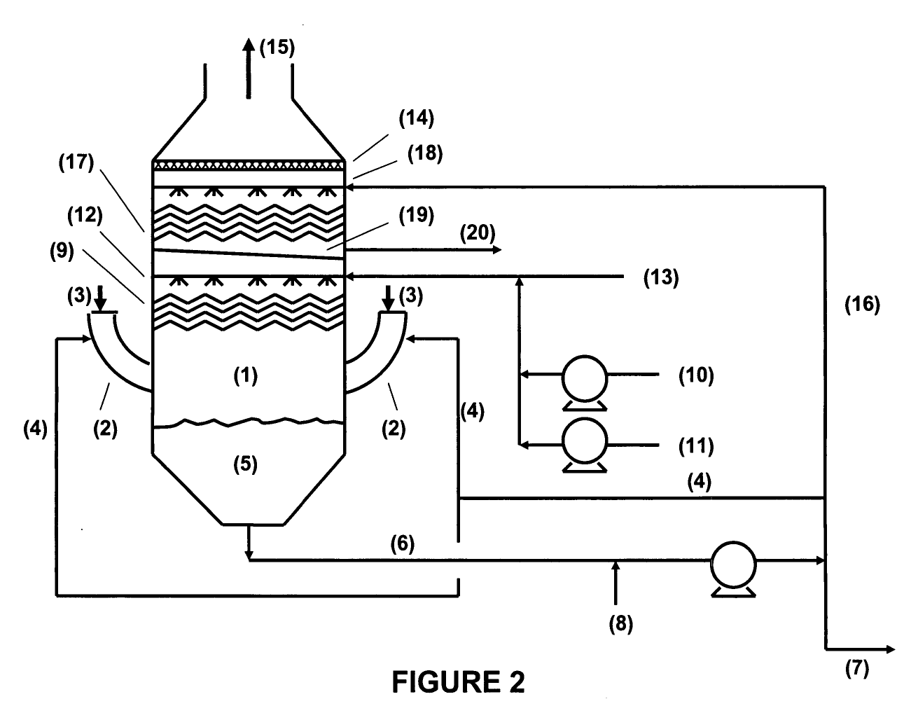

FIG. 2 illustrates another embodiment of the present invention to improve the oxidant products removal efficiencies of the overall system. Here, the processes shown by elements (1) through (15) in FIG. 2 are similar to the same processes and limitations as in elements (1) through (15) of FIG. 1 and described in one embodiment above. However, returning to FIG. 2, an upper contacting grid (17) has been added to the wet gas scrubber unit. In further describing FIG. 2 and the present embodiment, the contacting grid shown as element (9) will be referred to as the “lower contacting grid” to differentiate between the upper and lower grids in this embodiment. However, it should be re-emphasized that this “lower contacting grid” (9) in this embodiment performs essentially the same function in this embodiment as it did in the prior embodiment illustrated in FIG. 1.

Returning again to FIG. 2, in this embodiment, the reacted caustic solution from the wet gas scrubber bottom (5) that is removed from the wet gas scrubber via line (6) is not only recycled to the venturi nozzles of the wet gas scrubber through line (4), but a portion of the reacted caustic stream is conducted via line (16) to the upper spray header (18) located above the upper contacting grid (17) of the wet gas scrubber. This section of the process containing the upper contacting grid may also alternatively be referred to simply as the “third reaction zone”. Here, the reacted caustic solution is sprayed onto the upper contacting grid in an effort to provide maximum contact with the treated off-gas stream that is entering this zone from the lower contacting grid (i.e., second reaction zone) where the majority of the NO in the off-gas has been converted to oxidation products by reaction with the sodium hypochlorite and oxidant solution in the lower contacting grid. As stated earlier, one of the significant limitations with a single contacting grid arrangement is that when optimizing the proper combination and levels of sodium hypochlorite and oxidants used in the treatment solution in the lower contacting grid to maximize NO oxidation efficiency, that the treating solution can not effectively absorb the NO₂.

A problem with the final wash systems of the prior art is that the absorption efficiencies are not very efficient in removing the remaining NO₂ from the treated off-gas. While NO₂ can be scrubbed by alkaline solutions, the efficiency of this process drops dramatically at low NO₂ concentrations. The absorption of NO₂ by water or alkali is a second-order process on NO₂ and thus is feasible and effective at high concentration levels (>500 ppm) of NO₂, but is essentially negligible at the low NO₂ concentrations of a wet gas scrubber with a NOₓ oxidizing system. Calculations of the NO₂ absorption rate in 5 feet of structured grid indicated that only about 4% of a 50 ppm NO₂ regenerator off-gas can be absorbed by a caustic solution alone. Additionally, the cost of utilizing fresh chemical solutions for treatment in the upper contacting grid can add significant chemical costs to the operation as well as additional water usage and additional treatment costs for neutralizing these chemical compounds prior to proper disposal within permitting limits. Also, if the pH of the absorption solution is too high, calcium carbonate can precipitate out of solution resulting in significant plugging problems in the upper contacting grid, associated piping, strainers, and other associated equipment.

What has been discovered in this embodiment is an effective process utilizing the reacted caustic stream from the bottom of the wet gas scrubber (5) as an absorption solution in the upper contacting grid (17). This reacted caustic solution from the bottom of the wet gas scrubber has a high sulfite concentration and is more active than the alkaline solutions of the prior art. This is due to the fact that the reacted caustic solution from the wet gas scrubber has very high levels of sulfites (approximately 1,000 to about 30,000 ppm sulfite content) that were removed from the initial regenerator off-gas SOₓ scrubbing step in the wet gas scrubber in the first reaction zone. It therefore is desired to utilize the reacted caustic solution for use in this third reaction zone prior to it being subjected to an oxidizing step as shown via line (7). Although there is no upper limit of the molar ratio of the sulfites to NO₂ in the third reaction zone, this ratio should be at least 2, preferably at least 5, and more preferably at least 7 moles of sulfite per mole of NO₂.

Gaseous species can be scrubbed into a liquid phase using reactive absorption, in which a liquid phase reagent reacts with the gas species to create a soluble form of the gaseous molecule. The efficiency of this process is given approximately by the formula:

$$\frac{1}{ln ( \frac{{p}_{in}}{{p}_{out}} )} = \frac{1}{{N}_{g}} + \frac{G}{AH \sqrt{{k}_{eff} D}} \qquad ( 26 )$$

Chen H. Shen & Gary T. Rochelle, Nitrogen Dioxide Absorption and Sulfide Oxidation in Aqueous Sulfide, vol 49, Journal of Air and Waste Management Association, pages 332-338 (1999). As utilized in this formula, pᵢₙ and pₒᵤₜ are the partial pressures of the gas to be absorbed at the inlet and outlet, respectively; N_{g} is a measure of the gas-liquid contacting efficiency; G is the gas flow rate; A is the gas-liquid contacting area; H is the Henry's Law constant of the gas; k_{eff} is the effective first-order rate constant for the reaction between the gas and any liquid species; and D is the diffusion coefficient of the gas in the liquid. N_{g} is generally large and sets an upper limit to the absorption efficiency, an upper limit which is generally not approached in any chemical absorber such as those described herein.

At a fixed value of G, there are three ways to improve the efficiency of a gas-liquid scrubber: 1) increase the contacting area in the scrubber, either by more efficient packing or with a taller grid; 2) increase H or D, which is generally not feasible; or 3) increase the reaction rate, k_{eff}, between the gas and the liquid phase reagents. Option 1 is essentially limited by pressure drop and capital expense, and option 3 is essentially the only control parameter, subject to this type of absorptive reaction.

From this analysis, essentially two requirements are defined for the commercial feasibility of any NO₂ scrubbing system. First, it needs to have a fast reaction between NO₂ and a liquid-phase reagent. Secondly, the inorganic reagent needs to be very inexpensive, because of the large quantities that will be consumed in the process.

It is well known that the reactions between SO₃²⁻/HSO₃⁻ and NO₂ are reasonably fast and are shown as the following chemical equations:
SO₃²⁻(aq)+NO₂(aq)→SO₃⁻(aq)+NO₂⁻(aq) (27)
HSO₃⁻(aq)+NO₂(aq)→H⁺(aq)+SO₃⁻(aq)+NO₂⁻(aq) (28)
wherein,
the rate constant for the reaction shown in equation (27) is k₂₇=2×10⁷ M⁻¹s⁻¹, and
the rate constant for the reaction shown in equation (28) is k₂₈=5×10⁵ M⁻¹s⁻¹

Reactions 27 and 28 are second-order reactions. To convert the rate constants k₂₇ and k₂₈ to k_{eff}, they are multiplied by the concentration of SO₃²⁻ or HSO₃⁻, respectively, and summed. The parameters k₂₇ and k₂₈ are essentially constants, and the only variable left for control of the system is the concentration of SO₃²⁻ and HSO₃⁻. To maximize the absorption, the total concentration of HSO₃⁻/SO₃²⁻ should be as high as possible, and the pH of the system should be maintained above about 7.2, which is approximately the pKₐ of HSO₃⁻ for the wet gas scrubber conditions.

It has been discovered that the reacted caustic solution has sufficient sulfites to be utilized as an effective solution to absorb a substantial portion of the remaining NO₂ in the regenerator off-gas stream after contacting the treating solution in the oxidation step in the lower contacting grid. This results in a process for improving effective NOₓ removal of the overall process while saving substantial chemical and waste treatment costs.

For example, an average FCC unit may emit approximately 1000 tons of NOₓ each year. The current commercial cost of an effective sulfite is over $1.00 per pound. If 50% of this NOₓ is to be scrubbed using a purchased sulfite, at a sulfite to NO₂ molar ratio of at least 2, the annual expense in chemical costs alone is over $2 million annually assuming a perfect theoretical conversion.

Since the absorption solution of the present invention reutilizes an existing FCCU wet gas scrubber stream, little additional chemical costs for this absorption stream are required over the base operation of an existing or new FCC waste gas scrubber system. Additionally, since the reacted caustic stream is reutilized before being sent for waste treatment, the present invention provides higher off-gas NOₓ reductions with minimal incremental chemical and waste treatment costs.

Returning again to FIG. 2, it is important that this absorption solution utilized in the upper contacting grid be segregated from the lower contacting grid in the wet gas scrubber unit. In this embodiment, a chimney tray (19), or similar liquid/vapor segregation tray is utilized to collect the liquid solution leaving the upper contacting grid (17) and removed as a reacted absorption stream (20), which is now higher in nitrogen compound concentration than the absorption solution (16) that was sprayed onto the upper contacting grid. The liquid solution that is collected on the chimney tray (19) can then be removed from the wet gas scrubber as a reacted absorption stream (20) and recycled to the wet gas scrubber bottoms or sent to a waste treatment facility for further processing and disposal.

The off-gas leaving the top of the upper contacting grid (i.e., leaving the third reaction zone) is now lower in NO₂ and total NOₓ than the oxidized off-gas leaving the top of the lower contacting grid (i.e., leaving the second reaction zone). The off-gas leaving the top of the upper contacting grid is at least 20% lower, preferably about 40% to about 80% lower, and more preferably about 60% to about 80% lower in NO₂ than the oxidized off-gas leaving the top of the lower contacting grid. In this embodiment, NO Oxidation Efficiencies similar to the embodiment shown in FIG. 1 and described above are attainable. Additionally, Oxidation Products Removal Efficiencies of at least 60%, preferably at least 70%, and more preferably at least 80% may be achieved. The Oxidation Products Removal Efficiency for the system is expressed as a percentage and calculated by the formula:

$$\frac{{OS}_{in} - {OS}_{out}}{{OS}_{in}} \times 100 ( \% ) \qquad ( 29 )$$

where,
OSᵢₙ is the amount of oxidized species that are oxidized in the off-gas from NO by the present invention (in ppm), and
OSₒᵤₜ is the amount of oxidized species leaving the system in the final treated off-gas after treatment by the present invention (in ppm)

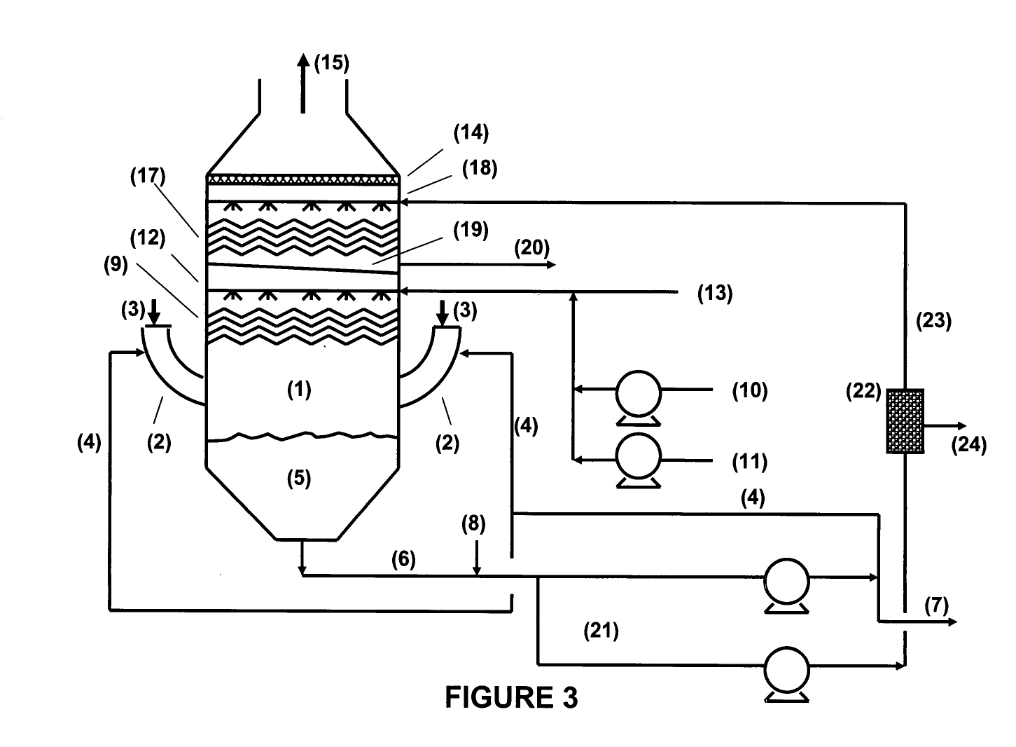

In still another embodiment shown in FIG. 3, the system process works similar to as shown in FIG. 2 and described in the related description above. The process illustrated by elements (1) through (20) in the present embodiment of FIG. 3 operate in a similar fashion to elements (1) through (20) depicted and described in FIG. 2. The major difference shown in FIG. 3 is that the reacted caustic stream to the upper distribution header (18) and the upper contacting grid (17) is first processed in a solids removal device (22) prior to being sent via line (23) to the upper distribution header (18). It should be noted that this solids removal device (22) may be located in line (21) instead of line (23) and this solids removal device can be any commercial available device for removing such particulates as found in a wet gas scrubber slurry be it of batch filtering or continuous filtering design (i.e., backwashing design), or other commercial units for solids removal such as, but not limited to, a hydroclone, centrifuge, or membrane system. If the device is a continuous particle removal or backflushing design, the particulates can be removed via line (24) for proper disposal as required. It is expected that this embodiment would obtain similar NO conversion efficiencies and similar NOₓ Reduction percentages and Oxidation Products Removal Efficiencies as the prior embodiment illustrated in FIG. 2 and described above.

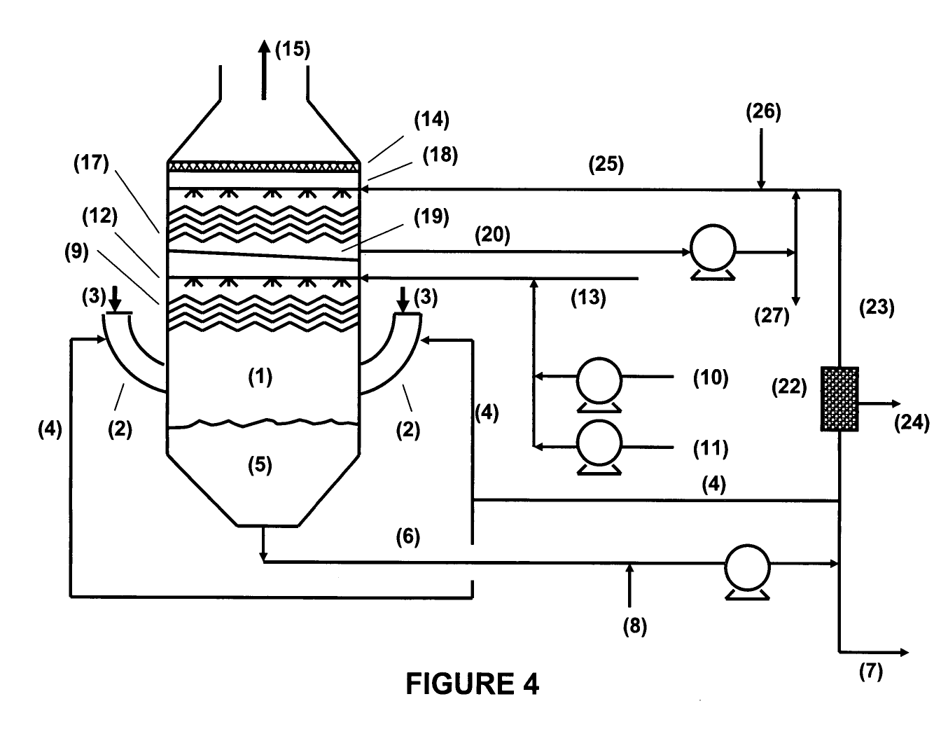

FIG. 4 illustrates another embodiment of the present invention. In this embodiment, the over system process works similar to as shown in FIG. 3 and described in the related description above. The process illustrated by elements (1) through (20) and (23) through (24) in the present embodiment of FIG. 4 operate in a similar fashion as the same numbered elements depicted and described in FIG. 3. However, in the embodiment depicted in FIG. 4, at least a portion of the reacted absorbent stream (20), is combined with the reacted caustic solution (23) and reintroduced into the third reaction zone via the upper spray header (18). A portion of the reacted absorbent stream may be removed via line (27). Additionally, caustic solution can be added as necessary via line (26) to maintain a proper pH level in the re-circulated absorption solution.

Generally, it is not desired to recycle the reacted absorbent stream for reuse in the upper contacting grid as it is desired to keep the sulfite concentration of the absorbent solution to this region as high as possible to achieve maximum NO₂ removal efficiencies. However, this configuration may be beneficial in certain situations, such as but not limited to, where capital and/or operation costs are to be minimized, a temporary installation is required, or where other existing equipment or process conditions and/or restrictions make this configuration attractive.

The above description of preferred embodiments is directed to preferred means for carrying out the present invention. Those skilled in the art will recognize that other means that are equally effective could be devised for carrying out the spirit of this invention.

### EXAMPLES

The following examples will illustrate the effectiveness of the various embodiments of the present process. These examples are for illustrative purposes only and are not meant to limit the present invention in any manner.

### Example 1

In this example, an embodiment of the present invention was tested on a commercial FCC unit regenerator off-gas stream. A regenerator off-gas stream with an approximate flow rate of 400,000 scfm was treated in accordance with the process of the present invention. A stream comprised of water, sodium chlorite (25% concentration NaClO₂ by weight), and sodium hypochlorite (12.5% concentration NaClO by weight) was introduced into the lower spray header above the lower contacting grid of the wet gas scrubber vessel at various volumetric injection levels. In this example, at the beginning of the test, only water and sodium chlorite (i.e., no sodium hypochlorite) was injected into the off-gas stream. This was followed by various levels of combined injections of sodium chlorite and sodium hypochlorite.

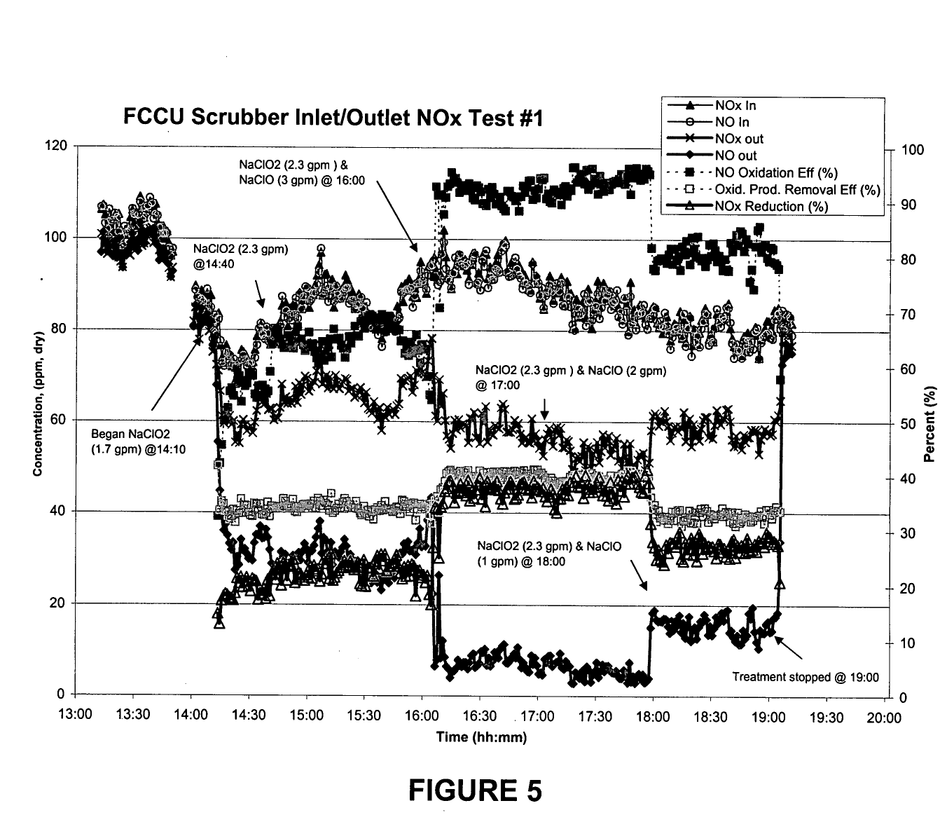

The overall test was run for approximately 5 hours (from 14:10 hours to 19:00 hours, see FIG. 5) and the results of the data are shown graphically in FIG. 5. This data is also summarized in Table 1, where the average results from each of the differing flow rate combinations is summarized.

TABLE 1
Data from Test #1

| | | NaClO | | | | | Oxidation | |
|---|---|---|---|---|---|---|---|---|
| | | to | WGS Slurry | | | NO | Products | |
| NaClO2 | NaClO | NaClO2 | to Upper | | | Oxidation | Removal | NOx |
| Injection | Injection | Ratio | Grid | NOx in | NOx out | Efficiency | Efficiency | Reduction |
| Rate | Rate | (molar | (estimated) | (average) | (average) | (average) | (average) | (average) |
| (gpm) | (gpm) | ratio) | (gpm) | (ppm) | (ppm) | (%) | (%) | (%) |
| 1.7 | 0.0 | 0.0 | 0.0 | 75.5 | 61.2 | 54.2 | 34.0 | 19.0 |
| 2.3 | 0.0 | 0.0 | 0.0 | 86.2 | 66.4 | 65.2 | 34.3 | 23.0 |
| 2.3 | 3.0 | 0.7 | 0.0 | 93.7 | 60.3 | 88.5 | 39.4 | 35.6 |
| 2.3 | 2.0 | 0.5 | 0.0 | 86.2 | 54.0 | 93.0 | 39.5 | 37.4 |
| 2.3 | 1.0 | 0.2 | 0.0 | 80.3 | 58.5 | 80.8 | 32.8 | 27.2 |

It can be seen from the data that upon introduction of the sodium hypochlorite with the sodium chlorite (at 16:00 hours) that the NO to NO₂ Oxidation Efficiency increased dramatically from about 65.2% with the sodium chlorite alone to about 88.5% with the combination of sodium hypochlorite and sodium chlorite (see Table 1). Correspondingly, the NO Oxidation Efficiency rate fell substantially when the sodium hypochlorite was reduced to 1.0 gpm at 18:00 hours.

This example shows that utilizing sodium hypochlorite in conjunction with sodium chlorite in the present invention can result in NO Oxidation Efficiencies of at least 80%, preferably at least 85%, and most preferably at least 90%. It can also be seen that overall NOₓ reductions of at least 30%, more preferably at least 35% can be achieved by the process of the present invention.

### Example 2

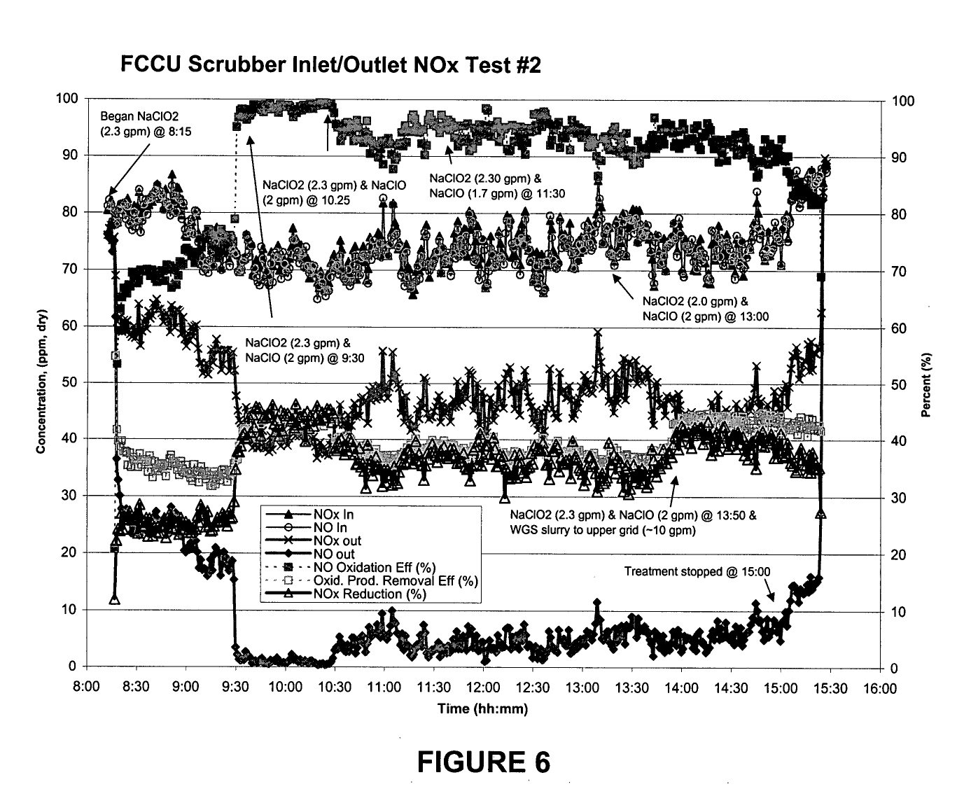

In this example, the present invention was again tested under similar conditions as in Example 1 above, at varying levels of combined injections of sodium chlorite and sodium hypochlorite. Again, a stream comprised of water, sodium chlorite (25% concentration NaClO₂ by weight), and sodium hypochlorite (12.5% concentration NaClO by weight) was introduced into the lower spray header above the lower contacting grid of the wet gas scrubber vessel of a commercial FCC unit at various volumetric injection levels. During the last stage of this test, a small stream of reacted caustic solution from the wet gas scrubber (a.k.a. “WGS slurry”), estimated at approximately 20 gpm, was conducted to the upper distribution header of the wet gas scrubber. The results of the WGS slurry testing are shown in the last row of Table 2 and in the last portion of FIG. 6 from 13:50 hours to 15:00 hours.

The overall test was run for approximately 7 hours (from 08:15 hours to 15:00 hours, see FIG. 6) and the results of the data are shown graphically in FIG. 6. This data is also summarized in Table 2, where the average results from each of the differing flow rate combinations is summarized.

TABLE 2
Data from Test #2

| | | NaClO | WGS | | | | Oxidation | |
|---|---|---|---|---|---|---|---|---|
| | | to | Slurry | | | NO | Products | |
| NaClO2 | NaClO | NaClO2 | to Upper | | | Oxidation | Removal | NOx |
| Injection | Injection | Ratio | Grid | NOx in | NOx out | Efficiency | Efficiency | Reduction |
| Rate | Rate | (molar | (estimated) | (average) | (average) | (average) | (average) | (average) |
| (gpm) | (gpm) | ratio) | (gpm) | (ppm) | (ppm) | (%) | (%) | (%) |
| 2.3 | 0.0 | 0.0 | 0.0 | 79.4 | 59.6 | 69.1 | 35.7 | 24.9 |
| 2.3 | 2.0 | 0.5 | 0.0 | 71.9 | 43.3 | 94.0 | 41.4 | 39.9 |
| 2.3 | 1.5 | 0.4 | 0.0 | 72.6 | 46.0 | 93.6 | 38.3 | 36.6 |
| 2.3 | 1.7 | 0.4 | 0.0 | 73.7 | 46.8 | 94.6 | 38.1 | 36.6 |
| 2.0 | 2.0 | 0.5 | 0.0 | 76.8 | 50.5 | 91.9 | 36.7 | 34.4 |
| 2.3 | 2.0 | 0.5 | 10.0 | 74.1 | 44.7 | 92.2 | 42.8 | 39.7 |

It can be seen from the data that upon introduction of the sodium hypochlorite with the sodium chlorite (at 09:30 hours) that the NO Oxidation Efficiency increased dramatically from about 69.1% with the sodium chlorite alone to about 94.0% with the combination of sodium hypochlorite and sodium chlorite (see Table 2). These results are similar to those experienced in Example 1. With differing rates of sodium hypochlorite injection the NO Oxidation Efficiencies were maintained above 90% as compared to below 70% without the sodium hypochlorite injections.

During the last part of this test, a small stream of reacted caustic solution from the bottom collection system of the wet gas scrubber was conducted to the upper distribution header of the wet gas scrubber. An increase from 36.7% to 42.8% can be seen in the Oxidation Products Removal Efficiency can be seen by injecting this small amount of WGS slurry by comparing the last two rows of Table 2. Also comparing this last data point with combinations of flow rates of equal NaClO₂ and NaClO injection rates (i.e., comparing the data from Row 2 of Table 2 to Row 5 of Table 2), it can be seen that by injecting the WGS slurry to the upper contacting grid that the Oxidation Products Removal Efficiency increased from 41.4% to 42.8% even though the NO Oxidation Efficiency dropped from 94.0% to 92.2%.

It is believed that good segregation may not have been maintained during this test resulting in the slight drop in NO Oxidation Efficiency, but shows that the addition of the WGS slurry, even in small amounts, can improve the Oxidation Products Removal Efficiency of the system.

Therefore, this example shows that utilizing sodium hypochlorite in conjunction with sodium chlorite in the present invention can result in NO Oxidation Efficiencies of at least 80%, preferably at least 85%, and most preferably at least 90%. Again, it can also be seen that overall NOₓ Reductions at least 30%, more preferably at least 35% can be achieved by the process of the present invention.

This example also shows that by adding the WGS slurry (a.k.a. the reacted caustic solution) from the wet gas scrubber to the upper contacting grid that Oxidation Products Removal Efficiencies of the system can be increased.

### Example 3

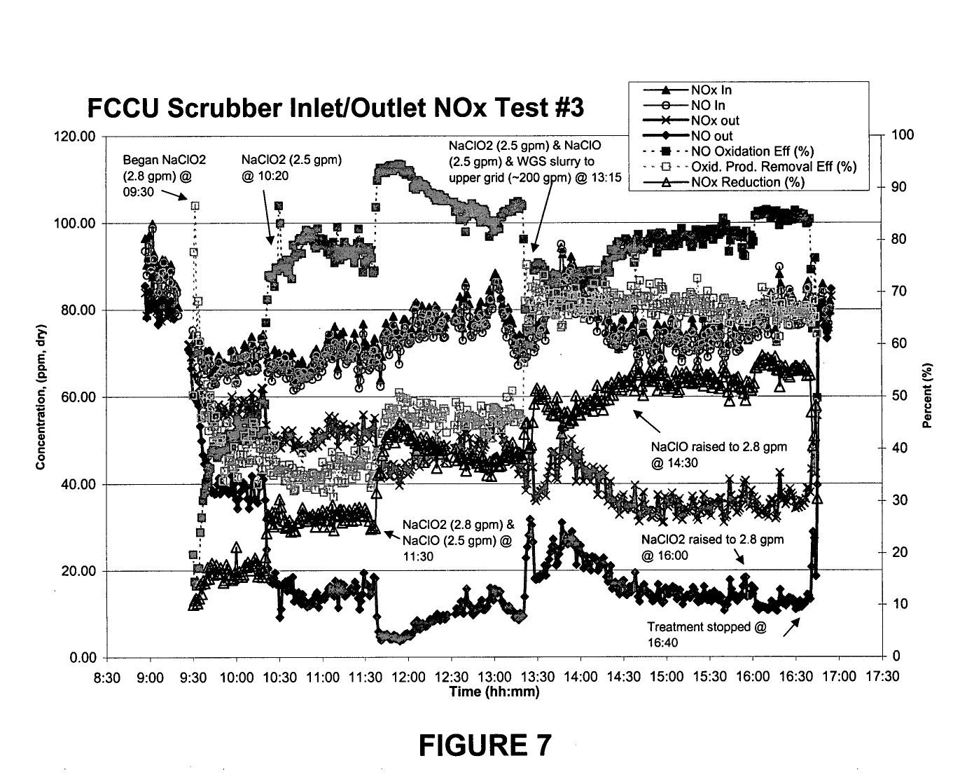

In this example, the present invention was again tested under similar conditions as in Example 2 above, at varying levels of combined injections of sodium chlorite and sodium hypochlorite. Again, a stream comprised of water, sodium chlorite (25% concentration NaClO₂ by weight), and sodium hypochlorite (12.5% concentration NaClO by weight) was introduced into the lower spray header above the lower contacting grid of the wet gas scrubber vessel of a commercial FCC unit at various volumetric injection levels. During the middle stage of this test, a stream of reacted caustic solution from the wet gas scrubber (a.k.a. “WGS slurry”), estimated at approximately 200 gpm was conducted to the upper distribution header of the wet gas scrubber. The results of the testing are shown in Table 3 and in FIG. 7.

The overall test was run for approximately 9½ hours (from 09:00 hours to 16:45 hours, see FIG. 7) and the results of the data are shown graphically in FIG. 7. This data is also summarized in Table 3, where the average results from each of the differing flow rate combinations is summarized.

TABLE 3
Data From Test # 3

| | | NaClO | WGS | | | | Oxidation | |
|---|---|---|---|---|---|---|---|---|
| | | to | Slurry | | | NO | Products | |
| NaClO2 | NaClO | NaClO2 | to Upper | | | Oxidation | Removal | NOx |
| Injection | Injection | Ratio | Grid | NOx in | NOx out | Efficiency | Efficiency | Reduction |
| Rate | Rate | (molar | (estimated) | (average) | (average) | (average) | (average) | (average) |
| (gpm) | (gpm) | ratio) | (gpm) | (ppm) | (ppm) | (%) | (%) | (%) |
| 2.8 | 0.0 | 0.0 | 0.0 | 68.8 | 57.4 | 41.1 | 41.7 | 16.6 |
| 2.5 | 0.0 | 0.0 | 0.0 | 69.4 | 50.7 | 77.6 | 35.8 | 26.9 |
| 2.5 | 2.5 | 0.5 | 0.0 | 77.4 | 47.6 | 87.3 | 45.1 | 38.4 |
| 2.5 | 2.5 | 0.5 | 200.0 | 81.6 | 42.5 | 71.7 | 68.2 | 48.0 |
| 2.5 | 2.8 | 0.6 | 200.0 | 73.9 | 34.8 | 80.3 | 67.4 | 52.9 |
| 2.8 | 2.8 | 0.5 | 200.0 | 80.6 | 36.8 | 83.1 | 66.3 | 54.4 |

As with the previous examples, it can be seen from the data that upon introduction of the sodium hypochlorite with the sodium chlorite (at about 10:30 hours) that the NO Oxidation Efficiency increased from about 77.6% with the sodium chlorite alone to about 87.3% with the combination of sodium hypochlorite and sodium chlorite (see Table 3).

During the later part of this test, a stream of reacted caustic solution from the bottom collection system of the wet gas scrubber (a.k.a. “WGS slurry”) was conducted to the upper distribution header of the wet gas scrubber. It should be noted that a substantially higher rate of WGS slurry (approximately 200 gpm) was injected in this example as compared to the rate of the WGS slurry in Example 2 (approximately 20 gpm). In addition, it is believed that in this later test there was better control on the segregation of the absorption solution between the upper and lower contacting grid zones (i.e., between the second reaction zone and the first reaction zone).

A significant increase from 45.1% to 68.2% can be seen in the Oxidation Products Removal Efficiency from injecting the WGS slurry above the upper contacting grid can be seen by comparing the third and fourth rows of Table 3. Also, it can be seen that by adding the WGS slurry to the third reaction zone that overall NOₓ reductions in the off-gas stream increased significantly from about 38.4% to 48.0% or higher at all of the NaClO₂ and NaClO rates tested. This is an increase in NOₓ reduction for the overall system of at least 25% versus not utilizing the WGS slurry in the third reaction zone.

It can be seen from this example that by utilizing the WGS slurry (a.k.a. the “reacted caustic solution”) from the bottom of the FCC wet gas scrubber as an absorbent in the upper contacting grid, in conjunction with the utilization of the specific ratios of sodium chlorite and sodium hypochlorite in the lower contacting grid that NO Oxidation Efficiencies of greater than 70%, preferably greater than 80% can be achieved. However, NO Oxidation Efficiencies similar to those in Examples 1 & 2 above are achievable if a good liquid separation is maintained between the second and third reaction zones. Also this embodiment can achieve Oxidation Product Removal Efficiencies of 50 to 60%, preferably at least 60%, and overall NOₓ Reductions of at least 40%, preferably at least 50% can be achieved.

1. A process for reducing NOₓ concentrations in the regenerator off-gas stream of a fluid catalytic cracking unit, which stream contains both NOₓ and SOₓ species, which process comprises:
a) removing at least a fraction of the SOₓ species from said regenerator off-gas stream in a first reaction zone thereby producing a SOₓ depleted off-gas stream;
b) contacting said SOₓ depleted off-gas stream in a second reaction zone with an effective amount of a treating solution comprised of sodium hypochlorite and an oxidant selected from sodium chlorite and chlorine dioxide at conditions that will oxide at least a fraction of the sulfites in said SOₓ depleted off-gas stream to sulfate and oxidize at least a fraction of the oxidizable NOₓ species in said SOₓ depleted off-gas stream to higher nitrogen oxides to produce a NO depleted off-gas stream; and
c) removing at least a fraction of said higher nitrogen oxides from said NO depleted off-gas stream to produce a treated regenerator off-gas stream.

2. The process of claim 1, wherein said sodium hypochlorite is introduced at a molar ratio from about 0.3 to about 3.0 moles of sodium hypochlorite per mole of sulfite in said second reaction zone.

3 . The process of claim 2, wherein said oxidant is introduced at a molar ratio from about 0.5 to about 3.0 moles of oxidant per mole of NO in said second reaction zone.

4. The process of claim 3, wherein the NO Oxidation Efficiency of the process is at least 70%.

5. The process of claim 4, wherein the NOₓ concentration of said treated regenerator off-gas stream is at least 30% lower than the NOₓ concentration of said regenerator off-gas stream.

6. The process of claim 5, wherein said sodium hypochlorite is introduced at a molar ratio from about 0.5 to about 2.0 moles of sodium hypochlorite per mole of sulfite in said second reaction zone.

7. The process of claim 6, wherein said oxidant is introduced at a molar ratio from about 0.5 to about 2.0 moles of oxidant per mole of NO in said second reaction zone.

8. The process of claim 7, wherein the NO Oxidation Efficiency of the process is at least 80%.

9. The process of claim 8, wherein said treating solution is introduced above a first contacting grid of a wet gas scrubber unit wherein said SOₓ depleted off-gas stream contacts said treating solution in said first contacting grid.

10. The process of claim 9, wherein the NOₓ concentration of said treated regenerator off-gas stream is at least 35% lower than the NOₓ concentration of said regenerator off-gas stream.

11. The process of claim 10, wherein the NO concentration of the treated regenerator off-gas stream is less than 20 ppmv.

12. The process of claim 10, wherein said sodium hypochlorite is introduced at a molar ratio from about 0.5 to about 1.5 moles of sodium hypochlorite per mole of sulfite in said second reaction zone.

13. The process of claim 12, wherein said oxidant is introduced at a molar ratio from about 0.6 to about 1.5 moles of oxidant per mole of NO in said second reaction zone.

14. The process of claim 13, wherein step a) is carried out by a wet desulfurization process selected from water scrubbing, alkali scrubbing, magnesia scrubbing, and ammonium scrubbing.

15. The process of claim 14, wherein the NO Oxidation Efficiency of the process is at least 90%.

16. The process of claim 15, wherein the NO concentration of the treated regenerator off-gas stream is less than 10 ppmv.

17. A process for reducing NOₓ concentrations in the regenerator off-gas stream of a fluid catalytic cracking unit, which stream contains both NOₓ and SOₓ species, which process comprises:
a) removing at least a fraction of the SOₓ species from said regenerator off-gas stream in a first reaction zone thereby producing a SOₓ depleted off-gas stream;
b) contacting said SOₓ depleted off-gas stream in a second reaction zone with an effective amount of a treating solution comprised of sodium hypochlorite and an oxidant selected from sodium chlorite and chlorine dioxide at conditions that will oxide at least a fraction of the sulfites in said SOₓ depleted off-gas stream to sulfate and oxidize at least a fraction of the oxidizable NOₓ species in said SOₓ depleted off-gas stream to higher nitrogen oxides to produce a NO depleted off-gas stream; and
c) contacting said NO depleted off-gas stream in a third reaction zone with an effective amount of an absorption solution comprised of the waste gas scrubber slurry solution from the bottom collection zone of a wet gas scrubber at conditions that will absorb at least a portion of the NO₂ in said NO depleted off-gas stream to produce a treated regenerator off-gas stream.

18. The process of claim 17, wherein said sodium hypochlorite is introduced at a molar ratio from about 0.3 to about 3.0 moles of sodium hypochlorite per mole of sulfite in said second reaction zone.

19. The process of claim 18, wherein said oxidant is introduced at a molar ratio from about 0.5 to about 3.0 moles of oxidant per mole of NO in said second reaction zone.

20. The process of claim 19, wherein the sulfite concentration of said absorption solution is greater than 1,000 ppmw.

21. The process of claim 20, wherein the NO Oxidation Efficiency of the process is at least 70%.

22. The process of claim 21, wherein the Oxidation Products Removal Efficiency of the process is from about 50% to about 60%.

23. The process of claim 22, wherein the NOₓ concentration of said treated regenerator off-gas stream is at least 30% lower than the NOₓ concentration of said regenerator off-gas stream.

24. The process of claim 23, wherein said absorption solution is introduced at a molar ratio of at least 2.0 moles of sulfite per mole of NO₂ in said third reaction zone.

25. The process of claim 24, wherein said sodium hypochlorite is introduced at a molar ratio from about 0.5 to about 2.0 moles of sodium hypochlorite per mole of sulfite in said second reaction zone.

26. The process of claim 25, wherein said oxidant is introduced at a molar ratio from about 0.5 to about 2.0 moles of oxidant per mole of NO in said second reaction zone.

27. The process of claim 26, wherein the NO Oxidation Efficiency of the process is at least 80%.

28. The process of claim 27, wherein the Oxidation Products Removal Efficiency of the process is at least 60%.

29. The process of claim 28, wherein said treating solution is introduced above a lower contacting grid of a wet gas scrubber unit wherein said SOₓ depleted off-gas stream contacts said treating solution in said lower contacting grid.

30. The process of claim 29, wherein said absorption solution is introduced above an upper contacting grid of a wet gas scrubber unit wherein said NO depleted off-gas stream contacts said absorption solution in said upper contacting grid.

31. The process of claim 30, wherein the sulfite concentration of said absorption solution is greater than 5,000 ppmw.

32. The process of claim 31, wherein said absorption solution is introduced at a molar ratio at least 5.0 moles of sulfite per mole of NO₂ in said third reaction zone.

33. The process of claim 32, wherein the NOₓ concentration of said treated regenerator off-gas. stream is at least 50% lower than the NOₓ concentration of said regenerator off-gas stream.

34. The process of claim 33, wherein the NO Oxidation Efficiency of the process is at least 90%.

35. The process of claim 34, wherein the Oxidation Products Removal Efficiency of the process is at least 70%.

36. The process of claim 35, wherein the NO concentration of the treated regenerator off-gas stream is less than 30 ppmv.

37. The process of claim 35, wherein step a) is carried out by a wet desulfurization process selected from water scrubbing, alkali scrubbing, magnesia scrubbing, and ammonium scrubbing.

38. The process of claim 37, wherein said sodium hypochlorite is introduced at a molar ratio from about 0.5 to about 1.5 moles of sodium hypochlorite per mole of sulfite in said second reaction zone.

39. The process of claim 38, wherein said oxidant is introduced at a molar ratio from about 0.6 to about 1.5 moles of oxidant per mole of NO in said second reaction zone.

40. The process of claim 39, wherein said absorption solution is introduced at a molar ratio of at least 7.0 moles of sulfite per mole of NO₂ in said third reaction zone.

41. The process of claim 40, wherein the NOₓ concentration of the treated regenerator off-gas stream is less than 50 ppmv.

42. The process of claim 41, wherein the NO concentration of the treated regenerator off-gas stream is less than 20 ppmv.
